(19) United States
(12) Patent Application Publication
(10) Pub. No.: US 2008/0218381 A1
(43) Pub. Date: Sep. 11, 2008

(54) OCCUPANT EXIT ALERT SYSTEM

(76) Inventors: Stephen J. Buckley, Novi, MI (US); Ted Selker, Palo Alto, CA (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/958,821

(22) Filed: Dec. 18, 2007

Related U.S. Application Data
(60) Provisional application No. 60/892,992, filed on Mar. 5, 2007.

(51) Int. Cl. B60Q 1/48

(52) U.S. Cl. 340/932.2; 340/573.1; 340/438

(57) ABSTRACT

A proximity sensor system for a vehicle that is parked includes a first remote sensor that senses objects in a rearward area relative to the vehicle. A park determination module determines the vehicle is parked. A door condition module determines a status of a door of the vehicle. A response module selectively responds to the objects based on door condition module signals and park determination module signals. An indicator responds to response module signals.

### CROSS-REFERENCE TO RELATED APPLICATION

This application claims the benefit of U.S. Provisional Patent Application Ser. No. 60/892,992, filed Mar. 5, 2007.

### FIELD OF THE DISCLOSURE

The present disclosure relates to sensor systems and more particularly to remote sensing systems for vehicles.

### BACKGROUND OF THE DISCLOSURE

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Drivers are often required to exercise judgment in the maneuvering of vehicles with respect to other objects that may be stationary or in motion. Such objects may be street signs, pedestrians, or other vehicles. This is particularly apparent when a vehicle is in reverse negotiating a parking space, driveway, and/or when the vehicle is towing a object. Although the use of side mirrors can assist, there may be blind spots.

Many vehicles include proximity sensing systems that provide the driver an indication of an object or, more preferably, the proximity of the object that may be obscured by a blind spot. Providing accurate vehicle situational information to the driver may improve vehicle navigation.

Further, when vehicles are parked and the driver is attempting to egress, blind spots may obscure approaching vehicles, bicycles, and/or stationary objects near the vehicle.

### SUMMARY OF THE DISCLOSURE

A proximity sensor system for a vehicle that is parked includes a first remote sensor that senses objects in a rearward area relative to the vehicle. A park determination module determines the vehicle is parked. A door condition module determines a status of a door of the vehicle. A response module selectively responds to the objects based on door condition module signals and park determination module signals. An indicator responds to response module signals.

In other features, a control method for a remote sensor system of a parked vehicle includes sensing first objects in a right rearward area relative to the vehicle. The method also includes sensing second objects in a left rearward area relative to the vehicle and sensing a location of an occupant in the vehicle. The method further includes determining a status of a door of the vehicle and estimating that one of the first and second objects will interfere with the door based on the location of the occupant. The method includes selectively responding to the first and second objects. The method includes turning off the system in response to the door open unless at least one of the objects is within an alert parameter.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a block diagram illustrating a proximity sensor system for a vehicle in accordance with the present disclosure;

FIG. 2 is a schematic diagram illustrating operation of the proximity sensor system in accordance with the present disclosure; and

FIG. 3 is a block diagram illustrating a method for operating the proximity sensor system in accordance with the present disclosure.

### DETAILED DESCRIPTION OF THE PREFERRED EMBODIMENTS

The following description is merely exemplary in nature and is in no way intended to limit the disclosure, its application, or uses. For purposes of clarity, the same reference numbers will be used in the drawings to identify similar elements. As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality. As used herein, the phrase at least one of A, B, and C should be construed to mean a logical (A or B or C), using a non-exclusive logical or. It should be understood that steps within a method may be executed in different order without altering the principles of the present disclosure.

A proximity sensor system for a vehicle, which may be a blind spot radar system, may detect vehicles and other objects in a blind spot when the vehicle is in motion. The system may also detect vehicles and other objects when the vehicle is stationary. The system may alert drivers and/or passengers to approaching or passing vehicles and other objects (such as motorcycles, bicycles, pedestrians, etc.) as they are about to open the vehicle doors. This may reduce risk of an open car door interfering or blocking the path of the passing object outside of the car.

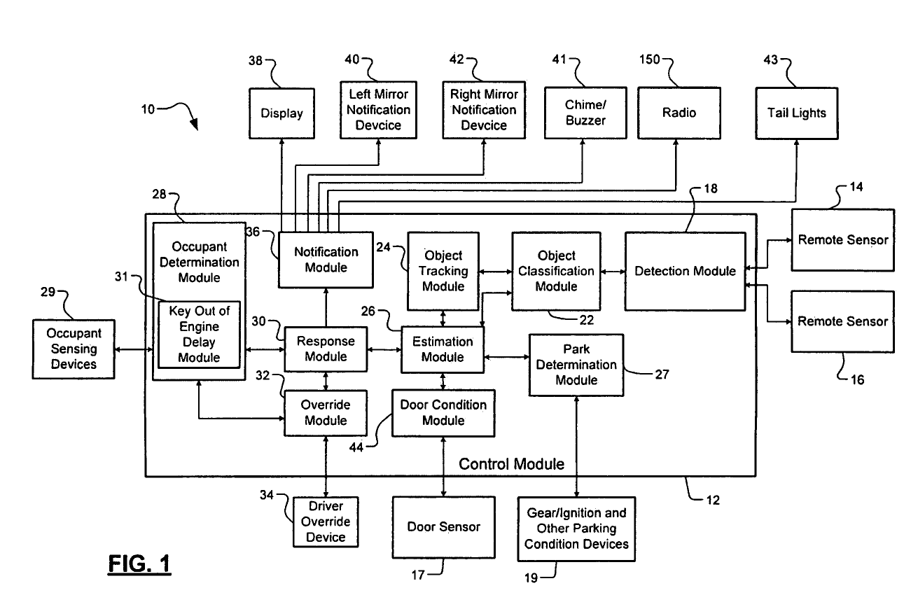

Referring now to FIG. 1, the vehicle system 10 includes a control module 12 that receives remote signals from first and second remote sensors 14, 16, a door sensor 17, and a parking condition device 19 that are coupled to a vehicle. A detection module 18 of the control module 12 determines that an object is approaching or is near to the vehicle based on signals from the remote sensors 14, 16. An object classification module 22 may classify sensed objects as, for example, a pedestrian, a bicycle, or another vehicle that have known and/or predictable patterns of movement.

An object tracking module 24 tracks the objects based on detection module signals. An estimation module 26 estimates a threat, such as a threat of impact between a vehicle door and an external object, based on object tracking module signals and object classification module signals. A park determination module 27 may determine the vehicle is parked based on parking condition device signals, which may include signals from a transmission system, an ignition system, etc. The park determination module 27 may communicate with other vehicle systems through a wired or wireless control area network (CAN) bus of the vehicle. The system 10 may be connected to the CAN bus to provide awareness of status of other electronic systems in the vehicle. Therefore, the system 10 may be aware of when the vehicle is no longer moving and is in the park gear.

An occupant determination module 28 determines that an occupant is present in the vehicle based on signals from occupant sensing devices 29. The occupant sensing devices 29 may include seat belt sensors, occupant classification system, and weight sensors in the seats. The occupant determination module 28 may determine that an occupant is present in a driver seat and/or a passenger seat.

A key out of ignition delay module 31 of the occupant determination module 28 determines and/or assumes that an occupant is present if the ignition key was removed and the door has not yet been opened. An ignition system of the vehicle may be activated through an ignition key or a keyless ignition system such as a proximity key sensing system. For example, if the proximity key is present, then the occupant determination module 28 may determine that an occupant is present.

A response module 30 responds to estimation module signals and occupant determination module 28 signals and determines various responses, if any, that vehicle systems will generate. The response module 30 may be overridden by an override module 32 controlled by a driver override device 34. Further, the response module 30 may deactivate the system 10 when no occupant is present in the vehicle.

The response module 30 may generate signals that control a notification module 36 such that the notification module 36 controls indicators, such as audible and/or visual indicators 38, 40, 41, 42 for the driver. Such indicators may include a visual display, such as parking display 38, a left mirror notification device 40, and/or a right mirror notification device 42. Such indicators may also include audible devices, such as chimes or buzzers 41. The parking display 38 may also display a message that an object was detected and/or request driver input as confirmation. Further, the notification module 36 may control tail lights 43 to warn pedestrians, vehicles, etc. that one or both of the doors are opening. A door condition module 44 may determine that a door is open, closed, and/or ajar based on door sensor signals.

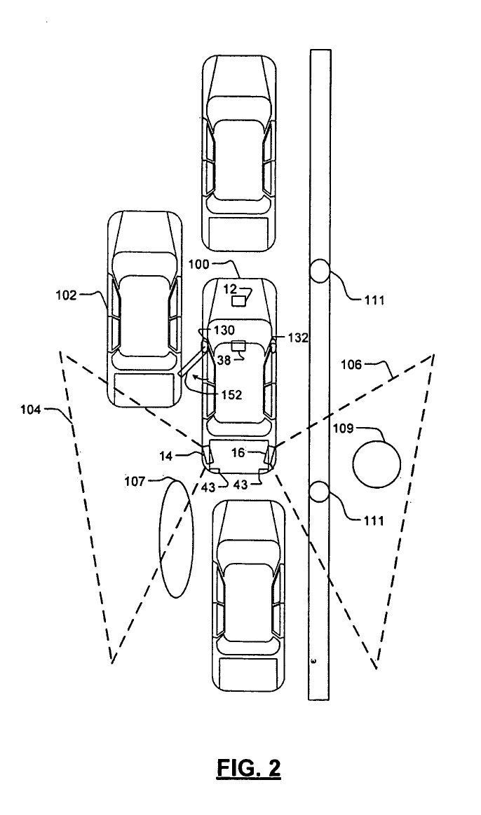

Referring now to FIGS. 1 and 2, the proximity system 10 may operate when a vehicle 100 is parked. The system 10 alerts a driver to position of objects, such as a vehicle 102, that are laterally positioned in relation to the vehicle 100 within zones of detection 104, 106 of the remote sensors. The remote sensors 14, 16 may be radar, lidar, vision based sensors or other remote sensors. The remote sensors 14, 16 may detect both position and speed of the vehicle 102 and other objects. Objects, such as the vehicle 102, that meet an alert criteria within the response module 30 may trigger both the visual and/or audible alert to the driver.

The sensors 14, 16 may identify the presence of bicycles 107, parking meters 111, pedestrians 109, and also garage structures, vehicles, trees, shopping carts, fire hydrants, boulders, toys, and other objects on the sides of the vehicle 100. All detected objects, regardless of size, moving or stationary, may trigger a visual and/or audio alert.

The vehicle 100 may include left and right side mirrors 130, 132. Left and right mirror notification devices 40, 42 may generate icons that appear on the side mirrors 130, 132 to illustrate a threat and/or a degree of threat. An icon may appear on the mirrors 130, 132 on the side of the vehicle 100 corresponding to the detected object. If objects are detected on both sides of the vehicle 100 icons (e.g. left and right mirror notification devices 40, 42) on both mirrors 130, 132 may be illuminated.

The vehicle 100 may also include the parking display 38 such that there is a redundant/secondary visual indication of an object in a rear cross path of the vehicle 100. A parking display 38, such as a Parksense visual display or a Parktronics visual display, may display a series of light-emitting diodes (LEDs) that indicate to the driver how far the vehicle 100 is to objects off the rear bumper of the vehicle 100. The parking display 38 may also include arrow icons that illustrate which direction the object or threat is in relation to the vehicle 100. The parking display 38 may illuminate simultaneously with icons on side mirrors 130, 132, such that the driver may use side mirrors, rear view mirrors, or visual confirmation by glancing back through a rear window of the vehicle 100 to determine threat. The response module may also trigger an audio alert such as a chime and/or buzzer 41 that may indicate relative threat to the vehicle based on estimation module and response module signals.

In one embodiment of the disclosure, both a visual and an audible alert may be triggered. During the audible alert, the system 10 may mute a radio 150 and may provide a tone from either or both a chime 41 and a parking display 38. These alerts may remain in effect until the object is no longer present or the object stops. If the object stops outside of a predetermined distance threshold, such as 4 meters, both the visual and audible alerts may cease. If the object stops inside of the threshold, the audible alert may stop but the visual alert may continue.

If the system detects an object approaching at a rate that exceeds the threshold mentioned above, and the driver/passenger opens a front/rear door that may intercept that object, the buzzer/chime may sound as a secondary warning (the visual alert may already be on). The audible alert may prevent the occupant from opening the door even further in an attempt to prevent the door and object from occupying the same space.

In typical operation, the system operates only when the ignition is on and the vehicle running. The system 10 may, however, remain active after the ignition is turned off. The system 10 may also remain powered until the door 152 corresponding to the detected passenger/driver is opened. If no object is detected as the vehicle door 152 is opened, the system 10 may power off to conserve energy. If the system 10 detects an object as the door 152 is opening, it may remain powered on to alert the driver/passenger and the passing object.

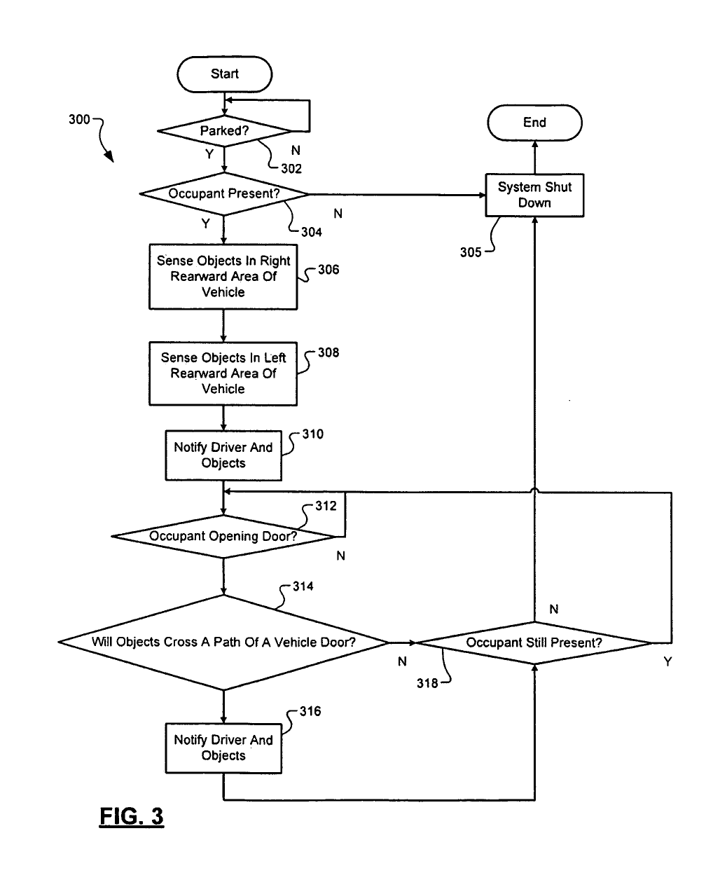

Referring now to FIG. 3, a block diagram 300 of an exemplary method for operating a proximity sensor system is illustrated. In step 302, the system determines that the vehicle is in park based on transmission gear, ignition switch, etc. If the vehicle is in park, the system may determine that a driver and/or passenger is present in step 304. To detect a driver or passenger, the system may either use information regarding the seat belt sensors, occupant classification system, weight sensors in the seats, or other future methods of determining occupant content. Step 304 may include an assumption that an occupant is present if the ignition key has been removed but a door has not been opened. Step 304 may also include an assumption that an occupant is present for a keyless ignition system when a pass key is present. Once the number of occupants is determined, the system will then be able to determine the side(s) of the vehicle to prepare the alerts. If there is no occupant present, the system may inhibit object tracking and alerting and shut down in step 305.

If step 304 is true, objects in right and left rearward areas of the vehicle are sensed in steps 306, 308. The system may begin checking for moving objects the moment the vehicle is placed in the park position. In step 310, the system may notify an occupant of the objects and notify the objects of the occupant. In step 312, a determination is made whether the occupant is opening the door. If step 312 is true, then if a moving object is identified in the rear/side of the vehicle, step 314 determines whether the object is moving in an intercept path with the swing of an opened vehicle door. If step 314 is true, the system may alert the driver/passenger on that side in step 316. The object may be moving at such a rate that the detected object and the opened vehicle door would intercept within a second window. If the object is moving too slow, the system may not alert. Stationary objects, unless stopped in the door swing zone, may not cause an alert to take place. The system may also check door status to see if it is closed, ajar, or open. The type of warning and severity may change based on the door status.

Step 316 also includes an alert to motorists, bicyclists, and pedestrians outside of the vehicle as well. If moving objects are detected outside of the vehicle, and they meet the rate/intercept criteria mentioned above, the tail lamp corresponding to that side of the vehicle may be illuminated as the door is opened (when door ajar or door open status is detected). In response to step 314 false or step 316, step 318 determines that no occupant is present, and the system is shut down in step 305. If an occupant is present in step 318, step 312 reactivates.

In operations a control method for a remote sensor system of a parked vehicle includes sensing first objects in a right rearward area relative to the vehicle. The method also includes sensing second objects in a left rearward area relative to the vehicle and sensing a location of an occupant in the vehicle. The method further includes determining a status of a door of the vehicle and estimating that one of the first and second objects will interfere with the door based on the location of the occupant. The method includes selectively responding to the first and second objects. The method includes turning off the system in response to the door open unless at least one of the objects is within an alert parameter.

The description of the disclosure is merely exemplary in nature and, thus, variations that do not depart from the gist of the disclosure are intended to be within the scope of the disclosure. Such variations are not to be regarded as a departure from the spirit and scope of the disclosure.

What is claimed is:

1. A proximity sensor system for a vehicle that is parked comprising:
a first remote sensor that senses objects in a rearward area relative to the vehicle;
a park determination module that determines the vehicle is parked;
a door condition module that determines a status of a door of the vehicle;
a response module that selectively responds to said objects based on door condition module signals and park determination module signals; and
an indicator that responds to response module signals.

2. The system of claim 1 further comprising an occupant determination module that determines that an occupant is present in the vehicle.

3. The system of claim 2 wherein said response module shuts down the system when no occupant is present in the vehicle.

4. The system of claim 2 further comprising an occupant sensing device that comprises at least one of a seat belt sensor, an occupant classification system, and a weight sensor, wherein said occupant determination module responds to said occupant sensing device.

5. The system of claim 2 wherein said occupant determination module determines that an occupant is present in at least one of a right and left side of the vehicle, and wherein said response module responds to said occupant on said at least one of said left and right side of the vehicle.

6. The system of claim 2 wherein said occupant determination module further determines that an occupant is present based on at least one of a removal of an ignition key from an ignition of the vehicle where said door has not been opened and a presence of a proximity key for a keyless ignition system.

7. The system of claim 1 further comprising an estimation module that estimates that at least one of said objects will intercept with said door based on first remote sensor signals and door condition module signals.

8. The system of claim 7 wherein said response module generates a warning signal based on estimation module signals.

9. The system of claim 1 wherein said park determination module activates when an ignition of the vehicle is turned off.

10. The system of claim 1 wherein said door condition module classifies a status for said door as at least one of ajar, closed, and open.

11. The system of claim 1 wherein said response module remains active until said door is opened unless at least one of said objects is within an alert parameter.

12. The system of claim 1 wherein said indicator comprises at least one of taillights of the vehicle, a vehicle visual display, and a vehicle audible display.

13. The system of claim 12 wherein said indicator comprises left and right side mirror indicators that selectively display icons based on said response module signals indicating one of said objects on at least one of left and right sides of the vehicle.

14. The system of claim 1 further comprising a second remote sensor that senses objects in another rearward area relative to the vehicle.

15. The system of claim 1 wherein said first remote sensor comprises at least one of a radar sensor, a lidar sensor, and a visual sensor.

16. The system of claim 1 further comprising an override module that overrides said response module.

17. A proximity sensor system for a vehicle that is parked comprising:
a first remote sensor that senses objects in at least one of a right rearward area relative to the vehicle and a left rearward area relative to the vehicle;
a park determination module that determines that an ignition of the vehicle is off;
an occupant determination module that determines a location of an occupant in the vehicle;
an estimation module that estimates that a door of the vehicle will intercept at least one of said objects based on first remote sensor signals and occupant determination module signals;
a response module that selectively responds to estimation module signals based on park determination module signals; and
an indicator that responds to response module signals.

18. The system of claim 17 wherein said response module shuts down the system when no occupant is present in the vehicle.

19. The system of claim 17 wherein said response module remains active until said door is opened unless at least one of said objects is within an alert parameter.

20. A control method for a remote sensor system of a parked vehicle comprising:
sensing first objects in a right rearward area relative to the vehicle;
sensing second objects in a left rearward area relative to the vehicle;
sensing a location of an occupant in the vehicle;
determining a status of a door of the vehicle;
estimating that one of said first and second objects will interfere with said door based on said location of said occupant;
selectively responding to said first and second objects; and
turning off the system in response to said door open unless at least one of said objects is within an alert parameter.
